(19) United States
(12) Patent Application Publication
(10) Pub. No.: US 2023/0345445 A1
(43) Pub. Date: Oct. 26, 2023

(54) USER EQUIPMENT BEAM MANAGEMENT CAPABILITY REPORTING

(71) Applicant: QUALCOMM Incorporated, San Diego, CA (US)

(72) Inventors: Tianyang BAI, Somerville, NJ (US); Yan ZHOU, San Diego, CA (US); Junyi LI, Fairless Hills, PA (US); Tao LUO, San Diego, CA (US)

(21) Appl. No.: 18/186,595

(22) Filed: Mar. 20, 2023

Related U.S. Application Data
(60) Provisional application No. 63/334,618, filed on Apr. 25, 2022.

(51) Int. Cl. H04W 72/044; H04L 5/00; H04W 72/21

(52) U.S. Cl. CPC H04W 72/046; H04L 5/0051; H04L 5/0023; H04L 5/0098; H04L 5/0035; H04W 72/21

(57) ABSTRACT

Certain aspects of the present disclosure provide techniques for method for wireless communications at a wireless device. The method generally includes obtaining a configuration for reporting beam management (BM) related information and outputting, for transmission, a BM report in accordance with the configuration, the BM report including an indication of a BM related capability.

### CROSS-REFERENCE TO RELATED APPLICATIONS

This application claims priority to U.S. Patent Application Ser. No. 63/334,618, entitled “UE BEAM MANAGEMENT CAPABILITY REPORTING,” filed Apr. 25, 2022, and assigned to the assignee hereof, the contents of each of which are hereby incorporated by reference in their entireties.

### BACKGROUND

### Field of the Disclosure

Aspects of the present disclosure relate to wireless communications, and more particularly, to techniques for reporting beam management (BM) related capability of a user equipment (UE).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications at a wireless device. The method includes obtaining a configuration for reporting beam management (BM) related information; and outputting, for transmission, a BM report in accordance with the configuration, the BM report including an indication of a BM related capability of the wireless device.

Another aspect provides a method of wireless communications at a wireless device. The method includes outputting, for transmission, a configuration for reporting BM related information; and obtaining a BM report in accordance with the configuration, the BM report including an indication of a BM related capability.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a call flow diagram illustrating an example of codebook based UL transmission, in accordance with certain aspects of the present disclosure.

FIG. 6 is a call flow diagram illustrating an example of non-codebook based UL transmission, in accordance with certain aspects of the present disclosure.

FIG. 7 depicts a call flow diagram for reporting beam management (BM) related capability of a UE, in accordance with certain aspects of the present disclosure.

FIG. 8 depicts a method for wireless communications.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for reporting beam management (BM) related capability of a wireless device. As used herein, the term wireless device (or wireless node) generally refers to any type of device capable of wireless communications, such as a UE or a network entity, such as a base station (e.g., a gNB).

Various enhancements for beam management (e.g., for communications between a UE and network entity) have been proposed and, in some cases, implemented. Such enhancements may be supported by reporting various BM measurements, for example, to support multiple transmitter and receiver point (mTRP) scenarios with UE panel information reporting.

One potential challenge is how a UE can indicate its capability to support such enhancements. Aspects of the present disclosure provide various mechanisms that may allow a UE to indicate BM-related capability. For example, techniques presented herein may allow a UE to send a panel related capability update in a physical layer (PHY or L1) beam report occasion.

One potential benefit to such an approach is that it may use existing BM reporting mechanisms to provide capability information efficiently (e.g., rather than relying on RRC signaling that may take longer). This approach may also allow flexibility in providing updates, for example, to adapt to changing conditions (e.g., to enhance throughput and/or conserve power).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

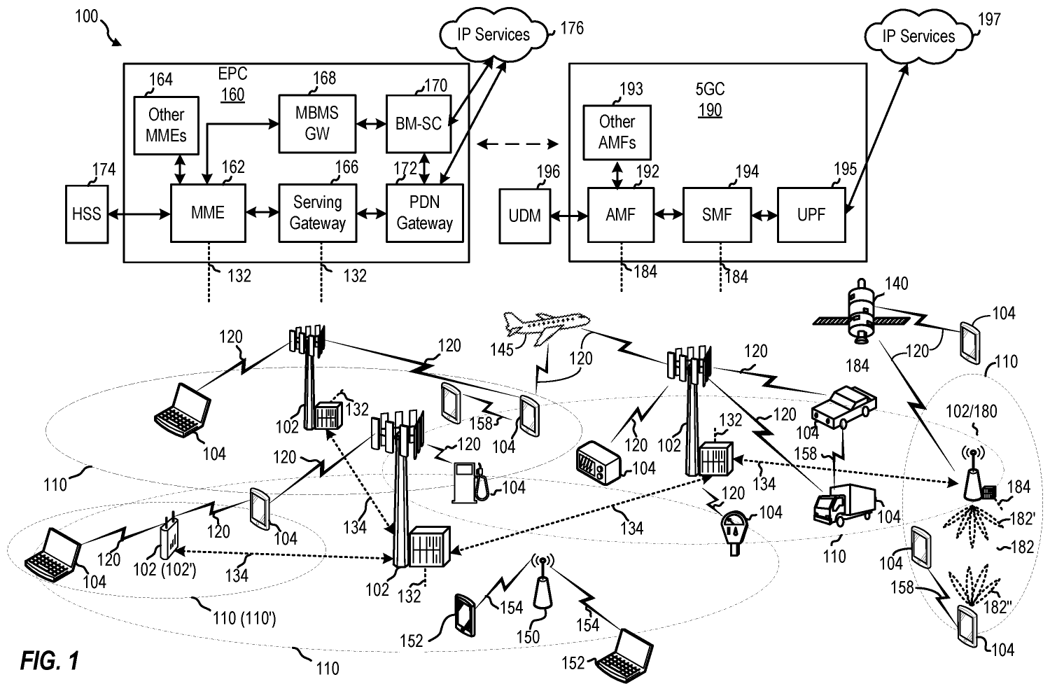

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) 190 network, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

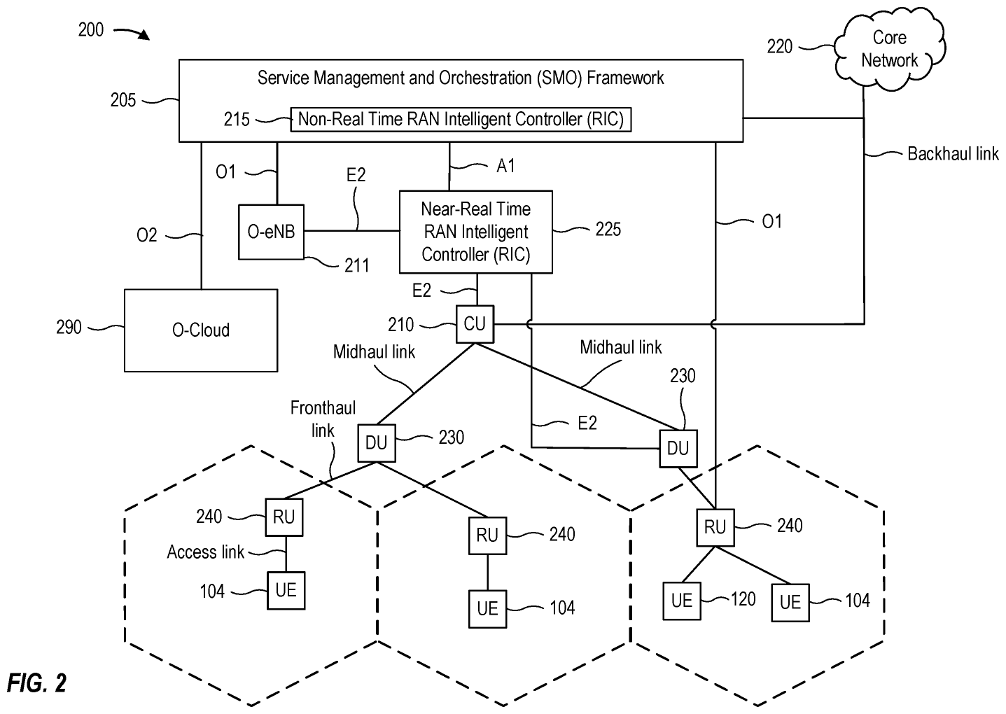

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

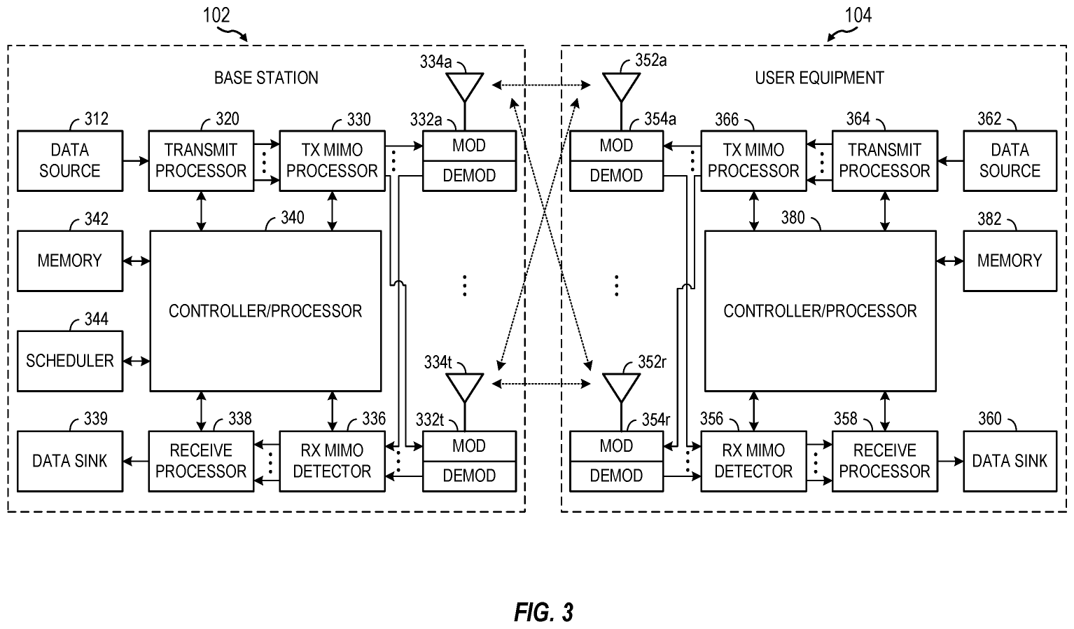

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

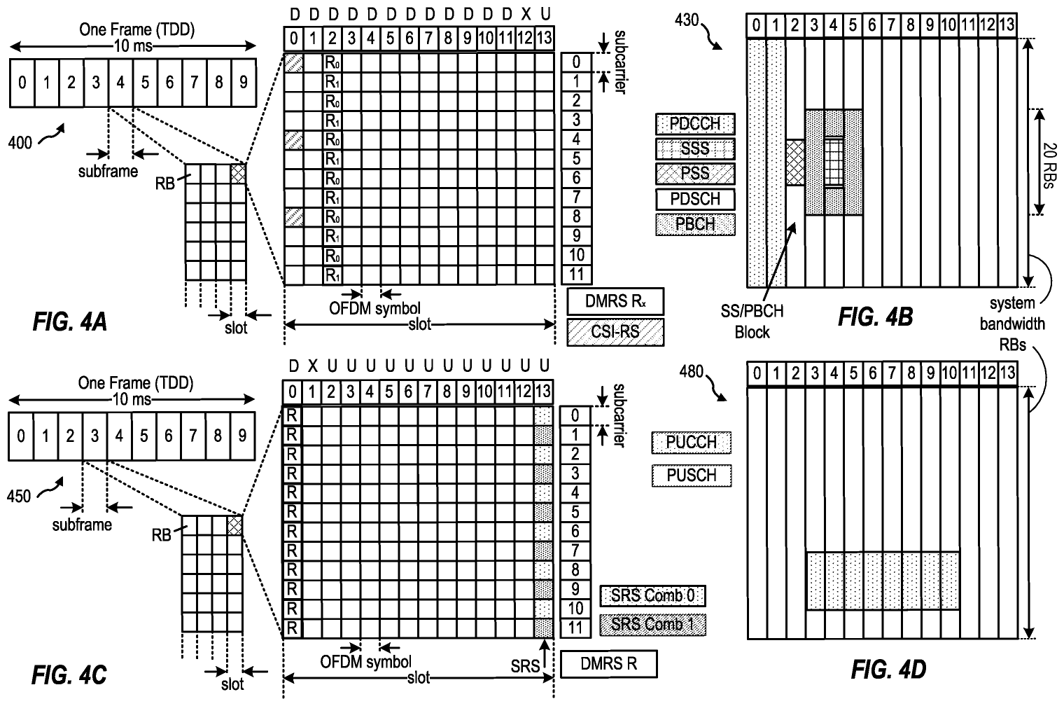

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2 slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Port and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL'd”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source reference signal (RS) is indicated in the top block and is associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS, rather it can be any other RS: PUSCH DMRS, CSIRS, TRS, and SRS.

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial Rx parameter},
   Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and Transmission Configuration Indicator (TCI) states.

As noted above, a subset of the TCI states provide quasi co-location (QCL) relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Search space information may also be provided via RRC signaling. For example, the SearchSpace IE is another RRC IE that defines how and where to search for PDCCH candidates for a given CORESET. Each search space is associated with one CORESET. The SearchSpace IE identifies a search space configured for a CORESET by a search space ID. In an aspect, the search space ID associated with CORESET #0 is SearchSpace ID #0. The search space is generally configured via PBCH (MIB).

### Example SRS Based Transmissions

Some deployments (e.g., NR Release 15 and 16 systems) support codebook-based transmission and non-codebook-based transmission schemes for uplink transmissions with wideband precoders. Codebook-based UL transmission is based on BS configuration and can be used in cases where reciprocity may not hold.

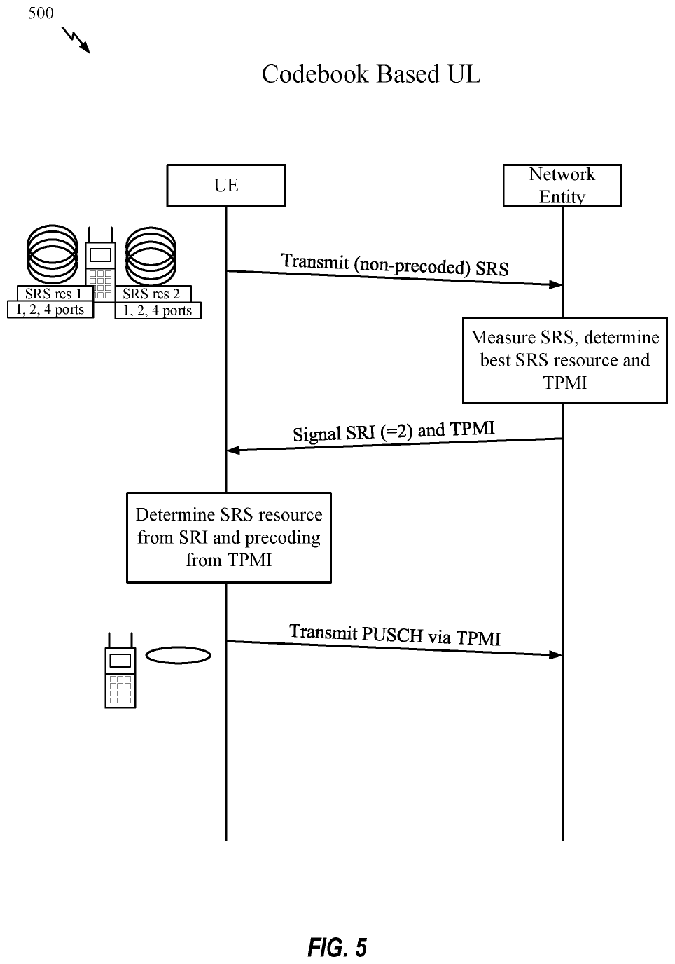

FIG. 5 is a call flow diagram 500 illustrating an example of conventional codebook based UL transmission using a wideband precoder. As illustrated, a UE transmits (non-precoded) SRS with up to 2 SRS resources (with each resource having 1, 2 or 4 ports). The gNB measures the SRS and, based on the measurement, selects one SRS resource and a wideband precoder to be applied to the SRS ports within the selected resource.

As illustrated, the gNB configures the UE with the selected SRS resource via an SRS resource indictor (SRI) and with the wideband precoder via a transmit precoder matrix indicator (TPMI). For a dynamic grant, the SRI and TPMI may be configured via DCI format 0_1. For a configured grant (e.g., for semi-persistent uplink), SRI and TPMI may be configured via RRC or DCI.

The UE determines the selected SRS resource from the SRI and precoding from TPMI and transmits PUSCH accordingly.

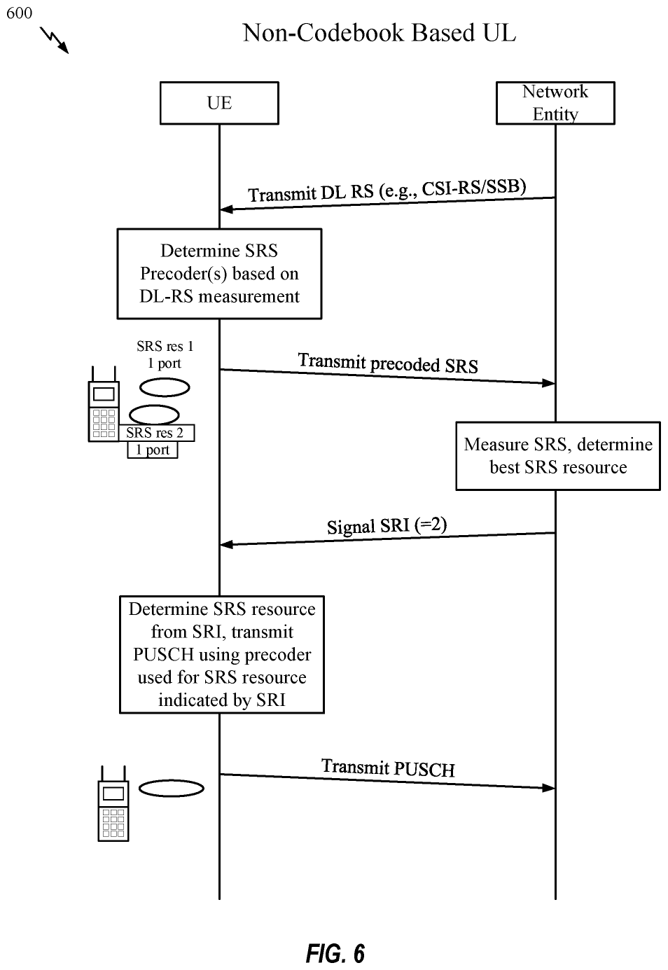

FIG. 6 is a call flow diagram 600 illustrating an example of non-codebook based UL transmission. As illustrated, a UE transmits (precoded) SRS. While the example shows two SRS resources, the UE may transmit with up to 4 SRS resources (with each resource having 1 port). The gNB measures the SRS and, based on the measurement, selects one or more SRS resource. In this case, since the UE sent the SRS precoded, by selecting the SRS resource, the gNB is effectively also selecting precoding. For non-codebook based UL transmission, each SRS resource corresponds to a layer. The precoder of the layer is actually the precoder of the SRS which is emulated by the UE. Selecting N SRS resources means the rank is N. The UE is to transmit PUSCH using the same precoder as the SRS.

As illustrated, the gNB configures the UE with the selected SRS resource via an SRS resource indictor (SRI). For a dynamic grant, the SRI may be configured via DCI format 0_1. For a configured grant, the SRI may be configured via RRC or DCI.

### Aspects Related to UE Beam Management Capability Reporting

Aspects of the present disclosure provide apparatuses, methods, processing systems, and computer-readable mediums for reporting beam management (BM) related capability of a UE.

As noted above, one potential challenge is how a UE can indicate its capability to support such enhancements. Aspects of the present disclosure provide various mechanisms that may allow a UE to indicate BM-related capability.

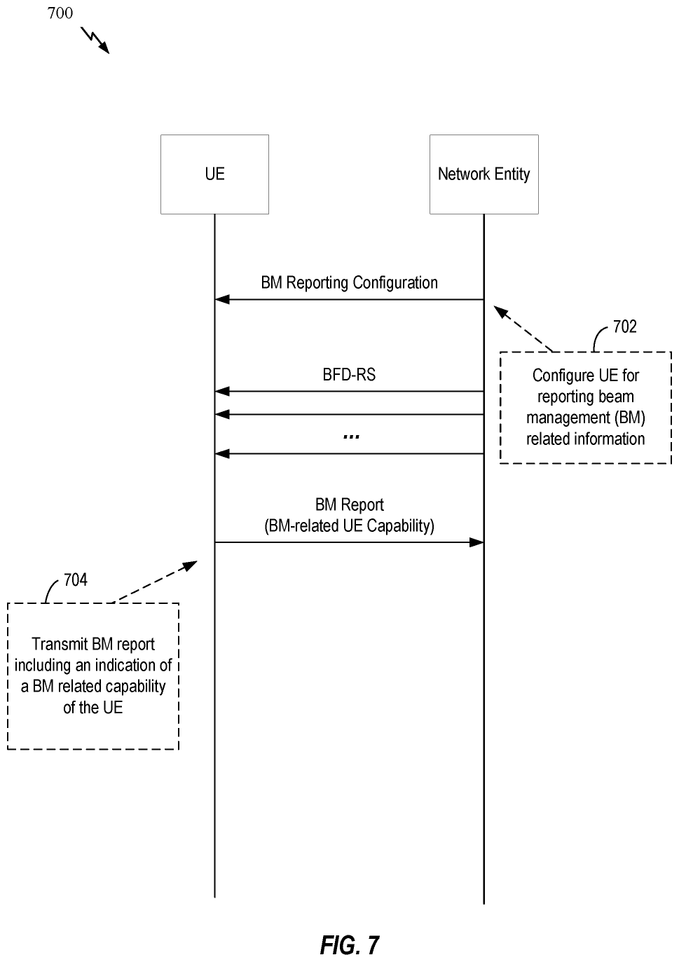

The techniques proposed herein may be understood with reference to the example call flow diagram 700 of FIG. 7.

As illustrated, a UE may be configured by a network entity (e.g., a gNB or component of a disaggregated base station) for beam management (BM) reporting 702. As illustrated, the UE may transmit a BM report that includes an indication of a BM related capability of the UE 704.

For example, this approach may allow the UE to send a panel related capability update in a layer one (L1) beam report occasion. In some cases, the panel related capability may include a metric that represents a maximum number of supported SRS ports for each panel (which may be associated with a TCI). In some cases, the UE may report an SSB ID, CSI RS ID, an L1 RSRP, and a maximum number of supported SRS ports.

In some cases, a new report quantity may be added (and configured) to support this feature in RRC (e.g., a new quantity to report the BM related capability in a BM report). For example, a new report quantity may be introduced, such as a ‘cri-RSRP-SetIndex’, ‘ssb-Index-RSRP-SetIndex’, ‘cri-SINR-SetIndex’, or ‘ssb-Index-SINR-SetIndex’ as a new report quantity in a CSI reporting setting.

In this context, a set index (parameter xxx-SetIndex) generally refers to the capability set index. For example, to indicate a number of supported ports, a SetIndex value may be ‘0’ for {1 port} or ‘1’ for {2 ports}.

In some cases, a UE capability of a maximum number of supported uplink transmit (UL Tx) layers may be determined based on one of various options. According to a first option, the number of supported UL Tx layers may be determined by the following equation:

min{maximum number of SRS ports for a reported set,maximum number of UL Tx layers reported by UE capability}.

According to another option, the maximum value of SRS ports in any reported capability value set may be no more than the reported UL Tx layers reported by the UE.

In some cases, the UE may report a panel related capability metric and indicate what type of time domain behavior the metric applies to. For example, the UE may indicate whether a reported capability is supported for periodic (P) reporting, aperiodic (AP) reporting, or semi-persistent (SP) reporting.

This may be beneficial, because UEs may not support all types of time domain behavior. For example, in some cases, P-reporting may be a baseline option, while AP reporting and SP reporting may be optional.

All types of time-domain behavior may be supported, however, for an enhanced beam report with index(es) of a UE capability value set. In such cases, which time domain behavior that a UE supports may be based on (indicated by) the UE capability report (e.g., an indication provided in a BM report). As an example, all UEs may be expected to support P reporting (e.g., as defined in standards), while SP and/or AP reporting may be left up to UE capability. In some cases, the candidate periodicities for periodic/SP reporting may be subject to UE capability. For example, a UE may have only limited power available, and periods between reporting may lengthen in order to reduce power consumption. In some cases, semi-persistent and/or aperiodic reporting may be triggered only when periodic reporting is configured.

In some cases, a UE may support a capability for updating a BFD-RS set per TRP BFR. For example, in some cases (e.g., in NR Rel 17), the TCI of a UE dedicated PDCCH/CORESET can be dynamically updated by DCI. For example, a previous TCI of a CORESET may be updated by MAC-CE. In some cases, a BFD-RS set can be configured to monitor the beams corresponding to CORESETs. In current systems, a BFD-RS set may only be configured by RRC, which takes much longer update time than DCI.

Aspects of the present disclosure may allow for faster update signaling, for example, via MAC-CE or DCI, to update a BFD RS. In some cases, per TRP BFR may be supported. For example, in such cases, a BFD RS set can be configured for each TRP and/or CORESET pool.

Aspects of the present disclosure may introduce a UE capability indicating whether the UE supports MAC-CE and/or DCI updating an explicit BFD RS set per TRP. If not supported, as indicated by the UE, explicit BFD RS may be RRC configured only (and not updated via MAC-CE and/or DCI). If supported, MAC-CE and/or DCI signaling may be used to select a BFD RS set per TRP from a RS pool configured in RRC. In some cases, a UE may report its UE capability on a maximum number of explicitly configured candidate BFD RS's per set pool or common pool for both sets for MAC-CE (or DCI) to down select.

In some cases, for single DCI (S-DCI) scenarios for an mTRP case, in a per TRP BFR process, after receiving gNB response, the UE may make certain assumptions. For example, the UE may assume that the QCL assumption of CORESETs associated with the failed BFD-RS sets is updated to the latest reported qnew beam (e.g., Qnew may be reported in BFR MAC-CE). In some cases, to associate a BFD-RS set with CORESETs, the UE may determine the CORESETs based on the RS indicated by the active TCI states and the associated BFD-RS set for the explicitly configured BFD-RS. In some cases, to associate a BFD-RS set with CORESET, there may be an explicit association between a CORESET(s) and explicitly configured BFD-RS set index(es) by RRC.

In some cases, for SCell BFR with a unified TCI framework, via UE capability for BFR, a UE may indicate whether it supports beam resetting for all channels and/or RSs applicable to the indicated TCI before the BFR is triggered. If not supported, only PDCCH and/or PDSCH may have beam resetting, while other channels and/or CSI-RS may not be reset. In some cases, the UE may indicate a UE capability as a maximum number of component carriers (CCs) configured with SCell BFR, if SpCell BFR is configured in the same band.

In some cases, a gNB may configure a CC list at the UE, where all CCs on the same list share the same TCI update and/or activation. In some cases, how many lists that a UE supports per cell group may be up to UE capability. According to certain aspects of the present disclosure, on MAC-CE-based and DCI-based beam indication, regarding the CC list for common TCI state ID update and activation, the maximum number of CC lists can be configured is 4 per cell group. In some cases, the maximum number of CC lists for a UE to support may be subject to its UE capability.

In a unified TCI framework, the TCI indicated by DCI format 1_1 or 1_2 may be applied to all UE dedicated PDSCH/PDCCH reception. For other channel/RSs, whether they follow the same indicated TCI (as UE dedicated PDSCH/PDCCH) may be configured by RRC. In some cases, within a unified TCI framework, for periodic and/or semi-persistent (P/SP) CSI-RS, the UE may assume that the indicated (Rel-17) TCI state is always applied. In other cases, whether to apply the indicated Rel-17 TCI state may be configured per CSI-RS resource CORESET by RRC—if not applied, a legacy MAC-CE signaling mechanism may be used. In other cases, the indicated Rel-17 TCI state may never be applied (e.g., the legacy MAC-CE signaling mechanism is always used). In other cases, the indicated Rel-17 TCI state is applied only when gNB does not configure any TCI state for the P/SP CSI-RS).

In some cases, for DL channels/signals that share the same indicated (Rel-17) TCI state as UE-dedicated reception on PDSCH/PDCCH, the following option on source RSs and QCL-Types may also be supported based on UE capability. CSI-RS for CSI may be configured for QCL-TypeA and QCL-TypeD source RS.

In some cases, on (Rel-17) DCI-based beam indication, for a carrier aggregation (CA) case, there are certain beam application time (BAT) configuration options across CCs when common TCI state ID update may not be configured/supported. According to one option, the BAT is configured per-CC. According to a second option, the same scheme as that with common TCI state ID update may be used (e.g., a common BAT is determined by the CC(s) with the smallest SCS in a band). According to a third option, a BAT list may be configured under the cell group configuration and applied for each CC in the CG. For CCs not configured with a common TCI state ID update, the BAT may be determined by the subcarrier spacing (SCS) of the active BWP of the CC. In some cases, on Rel-17 DCI-based beam indication, regarding application time of the beam indication for non-CA, the BAT may be configured/determined per-CC.

In some cases, a scheduling parameter K0 (e.g., that represents an offset between a DL slot where a PDCCH (DCI) for downlink scheduling is received and the DL Slot where PDSCH data is scheduled) may be chosen from a limited set including 0. According to certain aspects, for a DCI to indicate TCI update without scheduling a DL assignment, the UE may always assume a virtual PDSCH is scheduled in the same slot of the DCI (K0 field=0), to determine the type-1 HARQ ACK codebook for ACK to the DCI. For DCI format 1_1 and 1_2 with PDSCH assignment indicating TCI state, the acknowledgement to the TCI state update is the ACK of the PDSCH. A UE may receive multiple DCIs: each DCI schedules a PDSCH and indicates a TCI state update. DCIs may come at different times and the indicated TCI update can be different. ACKs to all the scheduled PDSCHs by those DCIs may be multiplexed and sent in the same PUCCH transmission (e.g., in the same ACK/NAK codebook).

In some cases, a rule may be provided to clarify which TCI state update indicated in the multiple DCIs will be executed by UE. For example, the application time of the TCI update may count from the ACK to the DCI, so all TCI indication from all above DCIs potentially will take effect at the same time, but only one can be actually performed. One example of such a rule is that the TCI state(s) indicated in DCI corresponding to the last position with ACK value in the HARQ-ACK codebook will count. In such cases, for the rest of DCIs, the TCI state update indication may be overridden by the DCI corresponding to the last position ACK.

In some cases, for beam indication with (Rel-17) unified TCI, in case of DCI format 1_1/1_2 without DL assignment, the field of “Carrier indicator” may be used in the DCI to indicate CC ID where the indicated TCI is updated. As an example, the DCI may be sent in CC1, the Carrier indicator field in the DCI may indicate CC2, and the TCI field in the DCI may indicate TCI2. In this case, TCI2 may then be updated in CC2, not in CC1.

In some cases, for a UE activated with more than one TCI state, (one TCI is from serving cell, at least one from one of the at least one non-serving cells), if the symbols of paging/short message/system information (SI) from a serving cell are not overlapped with the symbols of DL signals from a non-serving cell, the UE may receive both. If at least one symbol of paging/short message/SI from serving cell is overlapped with the symbol of DL signals from non-serving cell, the UE may receive paging/short message/SI.

In some cases, for a CORESET with index 0, the UE may make various QCL assumptions. For example, the assume may assume that a DM-RS antenna port for PDCCH receptions in the CORESET is quasi co-located with: the one or more DL RSs configured by a TCI state, where the TCI state is indicated by a MAC CE activation command or a TCI updating DCI for the CORESET, if any, or a SS/PBCH block the UE identified during a most recent random access procedure not initiated by a PDCCH order that triggers a contention-free random access procedure, if no MAC-CE activation/TCI updating TCI DCI command indicating a TCI state for the CORESET is received after the most recent random access procedure, or a SS/PBCH block the UE identified during a most recent configured grant PUSCH transmission. In some cases, the QCL information determined for DMRS for CORESET 0 also applies to any channel which shares the same QCL as the CORESET 0, e.g. any PDSCH, PUSCH, PUCCH which is scheduled by a DCI from the CORESET 0.

In some cases, for a TCI update in the case of a single DCI schedules multi-PDSCH, the applied TCI states can be updated using unified TCI framework within the span of multi-PDSCH. In this case, any PDSCH scheduled after the beam application time of the new TCI will follow the new TCI.

In some cases, for a TCI update in the case of a single DCI schedules multi-PDSCH, the applied TCI states cannot be updated using unified TCI framework within the span of multi-PDSCH. In this case, as long as the first PDSCH among the multiple PDSCHs is before the application time of the new TCI, all PDSCHs shall use the same TCI as the first PDSCH (e.g., all using the old TCI).

In some cases, for any SRS resource or resource set that does not share the same indicated Rel-17 TCI state(s) as dynamic-grant/configured-grant based PUSCH and all of dedicated PUCCH resources, but can be configured as a target signal of a Rel-17 UL or, if applicable, joint TCI (hence the Rel-17 UL or, if applicable, joint TCI state pool), a MAC-CE signaling for Rel-17 TCI state indication may include at least the following: TCI ID for each SRS resource, SRS resource set's cell ID, and SRS resource set's BWP ID. In such cases, the power control parameters for the SRS resource set may be derived based on the power control parameters associated with TCI indicated for the first SRS resource.

For example, techniques presented herein may allow a UE to send a panel related capability update in a physical layer (PHY or L1) beam report occasion.

### Example Operations of a User Equipment

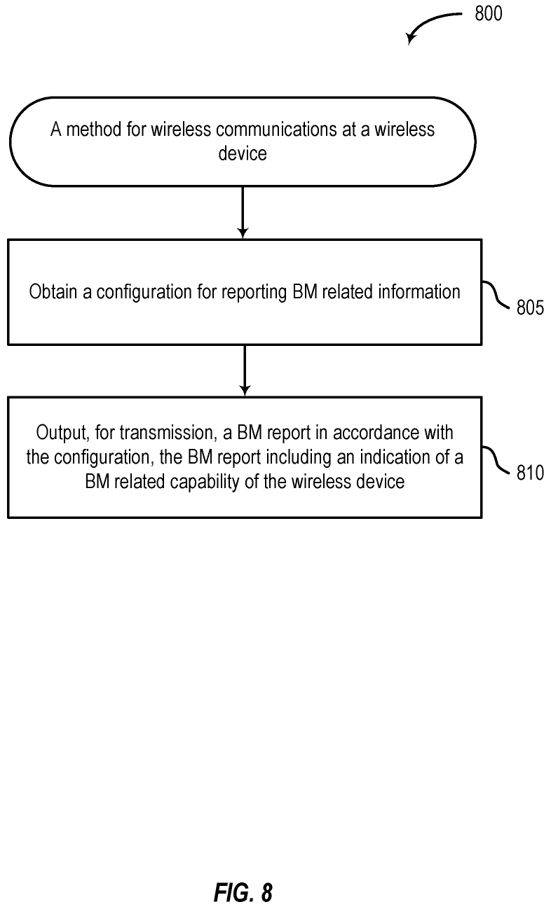

FIG. 8 shows an example of a method 800 for wireless communications by a wireless device, an example of which may be a UE, such as UE 104 of FIGS. 1 and 3.

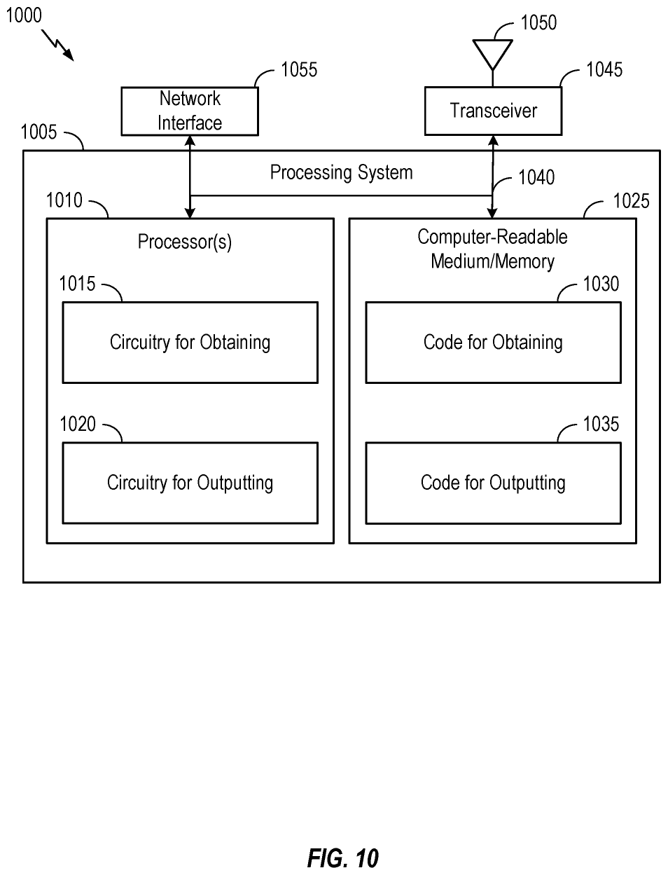

Method 800 begins at step 805 with obtaining (e.g., from a network entity) a configuration for reporting BM related information. In some cases, the operations of this step refer to, or may be performed by, circuitry for obtaining and/or code for obtaining as described with reference to FIG. 10.

Method 800 then proceeds to step 810 with outputting, for transmission (e.g., to the network entity), a BM report in accordance with the configuration, the BM report including an indication of a BM related capability of the wireless device. In some cases, the operations of this step refer to, or may be performed by, circuitry for outputting and/or code for outputting as described with reference to FIG. 10.

In some aspects, the configuration indicates at least one report quantity for indicating the BM related capability of the wireless device.

In some aspects, the BM related capability of the UE comprises a number of SRS ports per antenna panel or TCI supported by the wireless device.

In some aspects, the at least one report quantity comprises a capability set index.

In some aspects, the BM related capability of the UE comprises a number of supported uplink transmission layers supported by the wireless device.

In some aspects, the BM report also includes an indication of one or more time-domain BM reporting behaviors associated with the BM related capability of the UE.

In some aspects, the one or more time-domain reporting behaviors comprise at least one of: periodic reporting, semi-persistent reporting, or periodic reporting.

In some aspects, the BM related capability of the wireless device comprises a capability of the UE to support updating BFD RS indications via at least one of MAC-CE or DCI signaling.

In some aspects, the BM report indicates a number of configured candidate BFD RSs, from a pool of candidate BDF RSs, that may be down selected via the MAC CE or the DCI signaling.

In some aspects, the BM related capability of the wireless device comprises a capability of the UE to support beam resetting for multiple channels or RSs applicable to an indicated TCI before a BFR is triggered.

In some aspects, the BM report indicates a number of CCs of a band configured with a SCell BFR if a SpCell BFR is configured in the band.

In some aspects, the BM related capability of the wireless device comprises a number of CC lists supported by the UE, wherein all CCs in a CC list share a same TCI update or activation.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Operations of a Network Entity

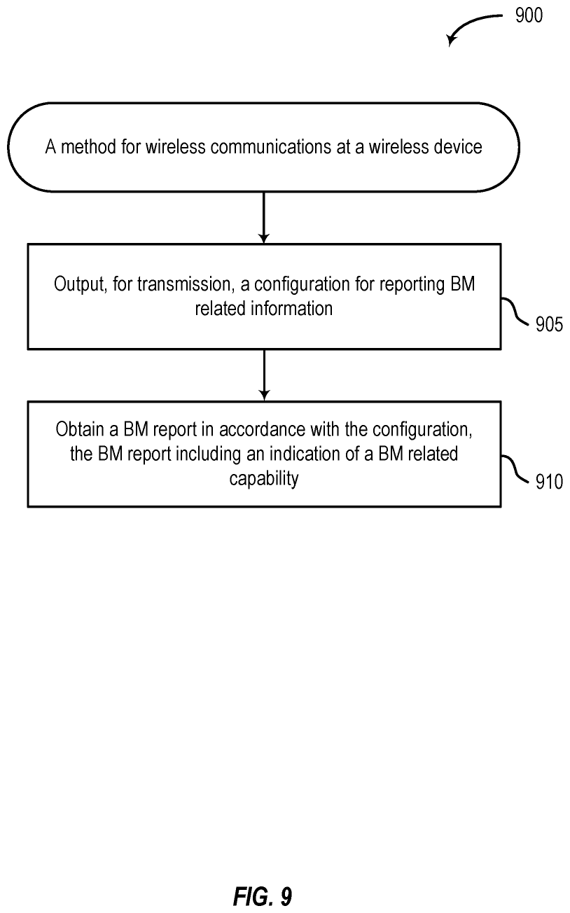

FIG. 9 shows an example of a method 900 for wireless communications by a wireless device, an example of which may include a network entity, such as BS 102 of FIGS. 1 and 3, or a disaggregated base station as discussed with respect to FIG. 2.

Method 900 begins at step 905 with outputting, for transmission (e.g., to a UE), a configuration for reporting BM related information. In some cases, the operations of this step refer to, or may be performed by, circuitry for outputting and/or code for outputting as described with reference to FIG. 10.

Method 900 then proceeds to step 910 with obtaining (e.g., from the UE), a BM report in accordance with the configuration, the BM report including an indication of a BM related capability (e.g., of the UE). In some cases, the operations of this step refer to, or may be performed by, circuitry for obtaining and/or code for obtaining as described with reference to FIG. 10.

In some aspects, the configuration indicates at least one report quantity for indicating the BM related capability.

In some aspects, the BM related capability of the UE comprises a number of SRS ports per antenna panel or TCI supported.

In some aspects, the at least one report quantity comprises a capability set index.

In some aspects, the BM related capability of the UE comprises a number of supported uplink transmission layers supported.

In some aspects, the BM report also includes an indication of one or more time-domain BM reporting behaviors associated with the BM related capability.

In some aspects, the one or more time-domain reporting behaviors comprise at least one of: periodic reporting, semi-persistent reporting, or periodic reporting.

In some aspects, the BM related capability of the UE comprises a capability to support updating BFD RS indications via at least one of MAC-CE or DCI signaling.

In some aspects, the BM report indicates a number of configured candidate BFD RSs, from a pool of candidate BDF RSs, that may be down selected via the MAC CE or the DCI signaling.

In some aspects, the BM related capability comprises a capability to support beam resetting for multiple channels or RSs applicable to an indicated TCI before a BFR is triggered.

In some aspects, the BM report indicates a number of CCs of a band configured with a SCell BFR if a SpCell BFR is configured in the band.

In some aspects, the BM related capability comprises a number of CC lists supported, wherein all CCs in a CC list share a same TCI update or activation.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

Means for establishing, means for measuring and means for calculating may include any of the various processors and/or transceivers shown in FIG. 3 or 9.

### Example Communications Device

FIG. 10 depicts aspects of an example communications device 1000. In some aspects, communications device 1000 is a user equipment, such as UE 104 described above with respect to FIGS. 1 and 3. In some aspects, communications device 1000 is a network entity, such as BS 102 of FIGS. 1 and 3, or a disaggregated base station as discussed with respect to FIG. 2.

The communications device 1000 includes a processing system 1005 coupled to the transceiver 1045 (e.g., a transmitter and/or a receiver). In some aspects (e.g., when communications device 1000 is a network entity), processing system 1005 may be coupled to a network interface 1055 that is configured to obtain and send signals for the communications device 1000 via communication link(s), such as a backhaul link, midhaul link, and/or fronthaul link as described herein, such as with respect to FIG. 2. The transceiver 1045 is configured to transmit and receive signals for the communications device 1000 via the antenna 1050, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code) that when executed by the one or more processors 1010, cause the one or more processors 1010 to perform the method 800 described with respect to FIG. 8, or any aspect related to it. In certain aspects, the computer-readable medium/memory 1025 is configured to store instructions (e.g., computer-executable code) that when executed by the one or more processors 1010, cause the one or more processors 1010 to perform the method 900 described with respect to FIG. 9, or any aspect related to it. Note that reference to a processor performing a function of communications device 1000 may include one or more processors 1010 performing that function of communications device 1000.

In the depicted example, computer-readable medium/memory 1025 stores code (e.g., executable instructions), such as code for obtaining 1030 and code for outputting 1035. Processing of the code for obtaining 1030 and code for outputting 1035 may cause the communications device 1000 to perform the method 800 described with respect to FIG. 8, or any aspect related to it. Processing of the code for obtaining 1030 and code for outputting 1035 may cause the communications device 1000 to perform the method 900 described with respect to FIG. 9, or any aspect related to it.

The one or more processors 1010 include circuitry configured to implement (e.g., execute) the code stored in the computer-readable medium/memory 1025, including circuitry such as circuitry for obtaining 1015 and circuitry for outputting 1020. Processing with circuitry for obtaining 1015 and circuitry for outputting 1020 may cause the communications device 1000 to perform the method 800 described with respect to FIG. 8, or any aspect related to it. Processing with circuitry for obtaining 1015 and circuitry for outputting 1020 may cause the communications device 1000 to perform the method 900 described with respect to FIG. 9, or any aspect related to it.

Various components of the communications device 1000 may provide means for performing the method 800 described with respect to FIG. 8, or any aspect related to it, as well as for performing the method 900 described with respect to FIG. 9, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1045 and the antenna 1050 of the communications device 1000 in FIG. 10. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1045 and the antenna 1050 of the communications device 1000 in FIG. 10.

### Example Clauses

Implementation examples are described in the following numbered clauses:

Clause 1: A method for wireless communications at a wireless device, comprising: obtaining a configuration for reporting BM related information; and outputting, for transmission, a BM report in accordance with the configuration, the BM report including an indication of a BM related capability.

Clause 2: The method of Clause 1, wherein the configuration indicates at least one report quantity for indicating the BM related capability.

Clause 3: The method of Clause 2, wherein the at least one report quantity indicates a number of SRS ports per antenna panel or TCI supported.

Clause 4: The method of Clause 2, wherein the at least one report quantity comprises a capability set index.

Clause 5: The method of any one of Clauses 1-4, wherein the BM related capability comprises a number of supported uplink transmission layers supported.

Clause 6: The method of any one of Clauses 1-5, wherein the BM report also includes an indication of one or more time-domain BM reporting behaviors associated with the BM related capability.

Clause 7: The method of Clause 6, wherein the one or more time-domain reporting behaviors comprise at least one of: periodic reporting, semi-persistent reporting, or periodic reporting.

Clause 8: The method of any one of Clauses 1-7, wherein the BM related capability of the UE comprises a capability of the UE to support updating BFD RS indications via at least one of MAC-CE or DCI signaling.

Clause 9: The method of Clause 8, wherein the BM report indicates a number of configured candidate BFD RSs, from a pool of candidate BDF RSs, that may be down selected via the MAC CE or the DCI signaling.

Clause 10: The method of any one of Clauses 1-9, wherein the BM related capability comprises a capability of the UE to support beam resetting for multiple channels or RSs applicable to an indicated TCI before a BFR is triggered.

Clause 11: The method of any one of Clauses 1-10, wherein the BM report indicates a number of CCs of a band configured with a SCell BFR if a SpCell BFR is configured in the band.

Clause 12: The method of any one of Clauses 1-11, wherein the BM related capability comprises a number of CC lists supported, wherein all CCs in a CC list share a same TCI update or activation.

Clause 13: A method for wireless communications at a wireless device, comprising: outputting, for transmission, a configuration for reporting BM related information; and obtaining a BM report in accordance with the configuration, the BM report including an indication of a BM related capability.

Clause 14: The method of Clause 13, wherein the configuration indicates at least one report quantity for indicating the BM related capability.

Clause 15: The method of Clause 14, wherein the at least one report quantity indicates a number of SRS ports per antenna panel or TCI supported.

Clause 16: The method of Clause 14, wherein the at least one report quantity comprises a capability set index.

Clause 17: The method of any one of Clauses 13-16, wherein the BM related capability of the UE comprises a number of supported uplink transmission layers supported.

Clause 18: The method of any one of Clauses 13-17, wherein the BM report also includes an indication of one or more time-domain BM reporting behaviors associated with the BM related capability.

Clause 19: The method of Clause 18, wherein the one or more time-domain reporting behaviors comprise at least one of: periodic reporting, semi-persistent reporting, or periodic reporting.

Clause 20: The method of any one of Clauses 13-19, wherein the BM related capability comprises a capability of the UE to support updating BFD RS indications via at least one of MAC-CE or DCI signaling.

Clause 21: The method of Clause 20, wherein the BM report indicates a number of configured candidate BFD RSs, from a pool of candidate BDF RSs, that may be down selected via the MAC CE or the DCI signaling.

Clause 22: The method of any one of Clauses 13-21, wherein the BM related capability of the UE comprises a capability of the UE to support beam resetting for multiple channels or RSs applicable to an indicated TCI before a BFR is triggered.

Clause 23: The method of any one of Clauses 13-22, wherein the BM report indicates a number of CCs of a band configured with a SCell BFR if a SpCell BFR is configured in the band.

Clause 24: The method of any one of Clauses 13-23, wherein the BM related capability comprises a number of CC lists supported, wherein all CCs in a CC list share a same TCI update or activation.

Clause 25: An apparatus, comprising: a memory comprising executable instructions; and a processor configured to execute the executable instructions and cause the apparatus to perform a method in accordance with any one of Clauses 1-24.

Clause 26: An apparatus, comprising means for performing a method in accordance with any one of Clauses 1-24.

Clause 27: A non-transitory computer-readable medium comprising executable instructions that, when executed by a processor of an apparatus, cause the apparatus to perform a method in accordance with any one of Clauses 1-24.

Clause 28: A computer program product embodied on a computer-readable storage medium comprising code for performing a method in accordance with any one of Clauses 1-24.

Clause 29: A user equipment (UE), comprising: at least one transceiver; a memory comprising instructions; and one or more processors configured to execute the instructions and cause the UE to perform a method in accordance with any one of Clauses 1-12, wherein the at least one transceiver is configured to at least one of receive the configuration or transmit the BM report.

Clause 30: A network entity, comprising: at least one transceiver; a memory comprising instructions; and one or more processors configured to execute the instructions and cause the network entity to perform a method in accordance with any one of Clauses 13-24, wherein the at least one transceiver is configured to at least one of transmit the configuration or receive the BM report.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
a memory comprising instructions; and
one or more processors configured to execute the instructions and cause the apparatus to:
obtain a configuration for reporting beam management (BM) related information; and
output, for transmission, a BM report in accordance with the configuration, the BM report including an indication of a BM related capability of the apparatus.

2. The apparatus of claim 1, wherein the configuration indicates at least one report quantity for indicating the BM related capability of the apparatus.

3. The apparatus of claim 2, wherein the at least one report quantity indicates a number of sounding reference signal (SRS) ports per antenna panel or transmission configuration indicator (TCI) supported by the apparatus.

4. The apparatus of claim 2, wherein the at least one report quantity comprises a capability set index.

5. The apparatus of claim 1, wherein the BM related capability of the apparatus comprises a number of supported uplink transmission layers supported by the apparatus.

6. The apparatus of claim 1, wherein the BM report also includes an indication of one or more time-domain BM reporting behaviors associated with the BM related capability of the apparatus.

7. The apparatus of claim 6, wherein the one or more time-domain reporting behaviors comprise at least one of: periodic reporting, semi-persistent reporting, or aperiodic reporting.

8. The apparatus of claim 1, wherein the BM related capability of the apparatus comprises a capability of the apparatus to support updating beam failure detection (BFD) reference signal (RS) indications via at least one of medium access control (MAC) control element (CE) or downlink control information (DCI) signaling.

9. The apparatus of claim 8, wherein the BM report indicates a number of configured candidate BFD RSs, from a pool of candidate BDF RSs, that may be down selected via the MAC CE or the DCI signaling.

10. The apparatus of claim 1, wherein the BM related capability of the apparatus comprises a capability of the apparatus to support beam resetting for multiple channels or reference signals (RSs) applicable to an indicated transmission configuration indicator (TCI) before a beam failure recovery (BFR) is triggered.

11. The apparatus of claim 1, wherein the BM report indicates a number of component carriers (CCs) of a band configured with a secondary cell (SCell) BFR if a special cell (SpCell) BFR is configured in the band.

12. The apparatus of claim 1, wherein the BM related capability of the apparatus comprises a number of component carrier (CC) lists supported by the apparatus, wherein all CCs in a CC list share a same transmission configuration indicator (TCI) update or activation.

13. The apparatus of claim 1, further comprising at least one at least one transceiver, wherein:
the at least one transceiver is configured to receive the configuration and transmit the BM report; and
the apparatus is configured as a user equipment (UE).

14. An apparatus for wireless communications, comprising:
a memory comprising instructions; and
one or more processors configured to execute the instructions and cause the apparatus to:
output, for transmission, a configuration for reporting beam management (BM) related information; and
obtain a BM report in accordance with the configuration, the BM report including an indication of a BM related capability.

15. The apparatus of claim 14, wherein the configuration indicates at least one report quantity for indicating the BM related capability.

16. The apparatus of claim 15, wherein the at least one report quantity indicates a number of sounding reference signal (SRS) ports per antenna panel or transmission configuration indicator (TCI) supported.

17. The apparatus of claim 15, wherein the at least one report quantity comprises a capability set index.

18. The apparatus of claim 14, wherein the BM related capability comprises a number of supported uplink transmission layers supported.

19. The apparatus of claim 14, wherein the BM report also includes an indication of one or more time-domain BM reporting behaviors associated with the BM related capability.

20. The apparatus of claim 19, wherein the one or more time-domain reporting behaviors comprise at least one of: periodic reporting, semi-persistent reporting, or aperiodic reporting.

21. The apparatus of claim 14, wherein the BM related capability comprises a capability to support updating beam failure detection (BFD) reference signal (RS) indications via at least one of medium access control (MAC) control element (CE) or downlink control information (DCI) signaling.

22. The apparatus of claim 21, wherein the BM report indicates a number of configured candidate BFD RSs, from a pool of candidate BDF RSs, that may be down selected via the MAC CE or the DCI signaling.

23. The apparatus of claim 14, wherein the BM related capability comprises a capability to support beam resetting for multiple channels or reference signals (RSs) applicable to an indicated transmission configuration indicator (TCI) before a beam failure recovery (BFR) is triggered.

24. The apparatus of claim 14, wherein the BM report indicates a number of component carriers (CCs) of a band configured with a secondary cell (SCell) BFR if a special cell (SpCell) BFR is configured in the band.

25. The apparatus of claim 14, wherein the BM related capability comprises a number of component carrier (CC) lists supported, wherein all CCs in a CC list share a same transmission configuration indicator (TCI) update or activation.

26. The apparatus of claim 14, further comprising at least one transceiver, wherein:
the at least one transceiver is configured to transmit the configuration and receive the BM report; and
the apparatus is configured as a network entity.

27. A method for wireless communications at a wireless device, comprising:
obtaining a configuration for reporting beam management (BM) related information; and
outputting, for transmission, a BM report in accordance with the configuration, the BM report including an indication of a BM related capability of the wireless device.
